(19) United States
(12) Patent Application Publication
(10) Pub. No.: US 2003/0228535 A1
(43) Pub. Date: Dec. 11, 2003

(54) Electrophotographic photoconductor and a method for manufacturing the same

(75) Inventors: Teruo Sasaki, Nagano (JP); Shinjirou Suzuki, Nagano (JP); Yoichi Nakamura, Nagano (JP)

Correspondence Address: STAAS & HALSEY LLP, SUITE 700, 1201 NEW YORK AVENUE, N.W., WASHINGTON, DC, 20005, US

(73) Assignee: Fuji Electric Imaging Device Co., Ltd., Nagano (JP)

(21) Appl. No.: 10/410,596

(22) Filed: Apr. 10, 2003

(30) Foreign Application Priority Data
Apr. 11, 2002 (JP) 2002-109357
Mar. 27, 2003 (JP) 2003-88341

(51) Int. Cl. G03G 5/06

(52) U.S. Cl. 430/78; 430/59.5; 430/56

(57) ABSTRACT

An electrophotographic photoconductor exhibits excellent electrophotographic performance, particularly high sensitivity. A method of manufacturing an electrophotographic photoconductor includes forming a photosensitive layer exhibiting high sensitivity using a coating liquid. The electrophotographic photoconductor includes a photosensitive layer that contains photoconductive substances, a principal component of which is a metallophthalocyanine compound and a subcomponent of which is a phthalocyanine compound having central elements of hydrogen. The content of the subcomponent is in a proportion of 1 μmol to 200 mmol with respect to 1 mol of the principal component. The manufacturing method uses a coating liquid containing photoconductive substances, including principal component of a metallophthalocyanine compound and a subcomponent of a phthalocyanine compound having central elements of hydrogen in a proportion of 1 μmol to 200 mmol with respect to 1 mol of the principal component.

### CROSS-REFERENCE TO RELATED APPLICATIONS

This application claims the benefit of Japanese Patent application no. 2002-109357, filed Apr. 11, 2002, and Japanese Patent application no. 2003-088341 filed Mar. 27, 2003 in the Japanese Patent Office, the disclosures of which are incorporated herein by reference.

### FIELD OF THE INVENTION

The present invention relates to an electrophotographic photoconductor (hereinafter also simply called “a photoconductor”) used in printers, copiers, and facsimile machines that employ an electrophotographic system, and to a method for manufacturing such a photoconductor. The invention relates in particular to an electrophotographic photoconductor exhibiting excellent sensitivity attained by improvement of a photoconductive substance in a photosensitive layer, and to a manufacturing method therefor.

### BACKGROUND OF THE INVENTION

An electrophotographic photoconductor is required to perform functions of holding surface charges in the dark, generating charges upon receipt of light, and transporting charges upon receipt of light. There are two types of photoconductors: a single-layer type of photoconductor that performs all these functions in a single layer, and a layered type of photoconductor that consists of two function-separated layers—a layer contributing mainly to charge generation, and a layer contributing to charge holding in the dark and charge transport upon receipt of light.

Image formation by means of an electrophotographic system using these electrophotographic photoconductors may apply a Carlson method, for example. The image formation according to this method proceeds by the processes of charging a photoconductor by corona discharge in the dark, forming electrostatic latent images of characters or drawings of an original on the charged photoconductor surface, developing the latent image with toners, and transferring and fixing the developed toner image on a carrier such as paper. After the toner image transfer, the photoconductor is subjected to removal of electric charges and residual toners, is discharged by light, and then is recycled.

Photosensitive materials conventionally used in the electrophotographic photoconductor include inorganic photoconductive substances such as selenium, a selenium alloy, zinc oxide, and cadmium sulfide dispersed in a resin binder, and organic photoconductive substances such as poly-N-vinylcarbazole, polyvinylanthracene, a phthalocyanine compound, and a bis-azo compound dispersed in a resin binder or vacuum-deposited.

Of these organic photoconductive substances, the application techniques of the phthalocyanine compounds in particular, have been extensively studied. The cases using only one type and a mixture of two types of phthalocyanine compounds have been reported.

Uses of intentionally mixed two or more types of phthalocyanine compounds are disclosed in Japanese Unexamined Patent Application Publication Nos. H2-170166, H2-84661, and H6-145550, for example. Most of the reported examples of the mixed use, however, concern mixed crystals, that is, report creation of new crystal forms. It is known that generation of the mixed crystals can change crystal stability, sensitivity, and lifetime, and the sensitivity of the phthalocyanines in the mixed crystalline form is changed. However, a problem remains in every report that electrical performances were not studied in detail when the mixing ratio of different phthalocyanine compounds was varied in a small interval.

Another example of using intentionally mixed two or more types of phthalocyanine compounds is disclosed in U.S. Pat. No. 5,773,181. The reference describes a method for controlling sensitivity by controlling a crystal form in a mixture of two or more types of phthalocyanine compounds by introducing fluoro groups in the benzene rings. The mixing ratio has been studied in detail. However, the examples in the patent are the results of studies on the cases with the element at the center being fixed, and no study has been done on the case of a mixture of phthalocyanine compounds with different central elements.

U.S. Pat. Nos. 5,418,107 and 5,153,313 also disclose that crystal stability, sensitivity, and a life time can be changed by mixing two or more phthalocyanines. The sensitivity of a principal component of metal-free phthalocyanine in particular, is enhanced by mixing the principal component with a subcomponent of gallium phthalocyanine, indium phthalocyanine, or titanyloxophthalocyanine. Nevertheless, no example of performance improvement has been disclosed in any case of mixing a metal-free phthalocyanine as a subcomponent with gallium phthalocyanine, indium phthalocyanine, or titanyloxophthalocyanine as a principal component. The closest example of performance improvement achieved by mixing a subcomponent with the principal component of titanyloxophthalocyanine is the case of mixing a subcomponent of vanadyloxophthalocyanine, that has a molecular structure very similar to that of the principal component of titanyloxophthalocyanine, with the principal component of titanyloxophthalocyanine. Because a metallophthalocyanine exhibits a higher performance than a metal-free phthalocyanine, performance improvement is easily facilitated by adding one of the metallophthalocyanines to a metal-free phthalocyanine. In the contrary case, that is, when a phthalocyanine having central elements of hydrogen, which includes metal-free phthalocyanine and exhibits lower performance, is added to a metallophthalocyanine, which exhibits higher performance, performance improvement is considered very difficult because of the difference of the performances between the two types of phthalocyanines. Thus, there has been very little study concerning the examples of the performance improvement.

Japanese Unexamined Patent Application Publication Nos. H3-35245 and 2001-115054 disclose a possibility of using two or more types of phthalocyanine compounds as a result of a side reaction that generates different type(s) of phthalocyanine in the process of phthalocyanine synthesis. These references, however, involve only the side-product of chlorinated titanyloxophthalocyanine in a titanyloxophthalocyanine. Concerning the chlorinated titanyloxophthalocyanine, it is known that the side product of two-chlorine-substituted compounds exists, as well as the side product of a one-chlorine-substituted compound. Nevertheless, these references only studied the single-chlorine-substituted compound concerning the relation between the content and the performance of the side product. Because a synthesis process of the metallophthalocyanine generates only a trace quantity of a phthalocyanine having central elements of hydrogen, the detection and the quantitative analysis may have been very difficult with conventional techniques.

As described above, although the use of phthalocyanine compounds is known for the photosensitive material of an electrophotographic photoconductor, the relationship between the mixing ratio and the electric performance, particularly sensitivity, has not been clarified yet in the case of using two or more types of phthalocyanine compounds.

### SUMMARY OF THE INVENTION

In view of the above problem, an aspect of the present invention is to provide an electrophotographic photoconductor exhibiting excellent electrophotographic performance, particularly sensitivity, by clarifying the above-described relationship.

Another aspect of the invention is to provide a method of manufacturing an electrophotographic photoconductor comprising a step for forming a photosensitive layer using a coating liquid that produces a photosensitive layer with high sensitivity.

Additional aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following description of the embodiments, taken in conjunction with the accompanying drawings:

FIG. 1 is a block diagram, not to scale, of an embodiment of an electrophotographic photoreceptor in accordance with the present invention.

FIG. 2 is a block diagram, not to scale, of another embodiment of an electrophotographic photoreceptor in accordance with the present invention.

### DETAILED DESCRIPTION OF THE PREFERRED EMBODIMENTS

Reference will now be made in detail to the present preferred embodiments of the present invention. As described below, the sensitivity of a photoconductor may be raised significantly when a phthalocyanine compound having central elements of hydrogen is utilized in a specified proportion as a sub-component with a metallophthalocyanine compound that is included as a charge generation substance in the photosensitive layer of the photoconductor. The embodiments of the present invention for an electrophotographic photoconductor have been accomplished based on the above finding.

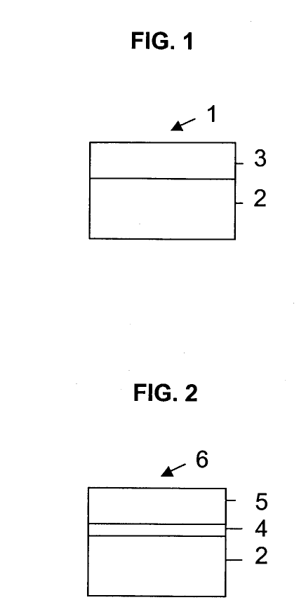

As shown in FIG. 1, an electrophotographic photoconductor 1 according to an embodiment of the present invention may comprise a conductive substrate 2 and a photosensitive layer 3 containing photoconductive substances, including a principal component of a metallophthalocyanine compound and a subcomponent of a phthalocyanine compound having central elements of hydrogen, the subcomponent being contained in a proportion of 1 μmol to 200 mmol with respect to 1 mol of the principal component.

Here, the metallophthalocyanine compound is a compound that contains an atom of a metallic element at the center of a phthalocyanine ring, and the phthalocyanine compound having central elements of hydrogen is a compound that contains two hydrogen atoms at a center of a phthalocyanine ring.

The sensitivity of a photoconductor may be raised significantly in a method of manufacturing an electrophotographic photoconductor comprising forming a photosensitive layer to coat a conductive substrate with a coating liquid, when the coating liquid contains a photosensitive substance that includes a principal component of a metallophthalocyanine and a subcomponent of a phthalocyanine compound having central elements of hydrogen in a specified proportion. The embodiment of the present invention for a method of manufacturing an electrophotographic photoconductor has been accomplished based on the above finding.

A method of manufacturing an electrophotographic photoconductor according to an embodiment of the present invention comprises coating a conductive substrate with a coating liquid containing a photoconductive substance that includes a principal component of a metallophthalocyanine compound and a subcomponent of a phthalocyanine compound having central elements of hydrogen, the subcomponent being contained in a proportion of 1 μmol to 200 mmol with respect to 1 mol of the principal component.

In the manufacturing method of this embodiment of the present invention, the metallophthalocyanine compound comprises a compound that contains an atom of a metallic element at the center of a phthalocyanine ring, and the phthalocyanine compound having central elements of hydrogen comprises a compound that contains two hydrogen atoms at a center of a phthalocyanine ring.

According to embodiments of the invention, a photosensitive layer of an electrophotographic photoconductor may be either of a single layer type or a layered type, and either of a negative charging type or a positive charging type, and is not limited to any one combination of these types. Further, a coating method in the manufacturing method may be a dip-coating method, a spray-coating method, and or any other suitable method, and is not limited to any one specific method.

Electrophotographic photoconductors are classified into negative charging layered type photoconductors, positive charging layered type photoconductors, and positive charging single layer type photoconductors. Embodiments of the invention are described specifically using examples of a negative charging layered type photoconductor and a positive charging single layer type photoconductor. A composition and a method of manufacturing a photoconductor may be appropriately selected from the known substances and methods except for the phthalocyanine compounds involved in the invention.

As shown in FIG. 2, in another embodiment, an electrophotographic photoconductor 6 may be a function-separated photoconductor comprising a charge generation layer 4 and a charge transport layer 5, laminated on the conductive substrate 2. A negative charging layered type photoconductor is formed by laminating a photosensitive layer on an undercoat layer or an intermediate layer, which in turn is laminated on the conductive substrate. A positive charging single layer type photoconductor is also formed by laminating a photosensitive layer on an undercoat layer or an intermediate layer. In this example, the photoconductor is a single layer type photoconductor in which a single photosensitive layer performs both charge generation and charge transport functions. Both types of photoconductors are not necessarily provided with an undercoat layer, and may also be provided with a protective layer.

The conductive substrate acts as an electrode of the photoconductor, and at the same time, as a support for the other layers. The substrate may take a form of a drum, a plate, or a film. The material of the substrate may be a metal of aluminum, stainless steel, or nickel, or glass or a resin with conductive surface treatment.

The undercoat layer is composed mainly of resin, or an oxide film such as alumite. The undercoat layer is provided as needed for the purpose of preventing excessive charges from being injected to the photosensitive layer from the conductive substrate, covering defects on the substrate surface, and improving adhesive quality between the substrate and the photosensitive layer. Binder resins for the undercoat layer may be selected from a copolymer of vinyl chloride, vinyl acetate, and another resin component, polycarbonate resin, polyester resin, poly(vinyl acetal) resin, poly(vinyl butyral) resin, poly(vinyl alcohol) resin, poly(vinyl chloride) resin, poly(vinyl acetate) resin, polyethylene, polypropylene, polystyrene, acrylic resin, polyurethane resin, epoxy resin, melamine resin, silicone resin, polyamide resin, polyacetal resin, polyallylate resin, polysulfone resin, polymethacrylate, and copolymers of these compounds. These compounds may be used alone or in a suitable combination. Preferable resins for use in a layered type photoconductor in particular, include alcohol-soluble polyamide, solvent-soluble aromatic polyamide, and thermosetting polyurethane resin. The alcohol-soluble polyamide may preferably be selected from the copolymers such as nylon 6, nylon 8, nylon 12, nylon 66, nylon 610, nylon 612, and N-alkyl-modified or N-alkoxyalkyl-modified nylon. Commercially available compounds of these polyamides include AMILAN CM8000 (6/66/610/12 copolymer nylon, a product of Toray Industries Co., Ltd.), ELBAMIDE 9061 (6/66/612 copolymer nylon, a product of Du Pont Japan Ltd.), and DAIAMIDE T-170 (a copolymer nylon mainly composed of nylon 12, a product of Daicel-Huels Co. Ltd.).

The undercoat layer may contain fine particles of a metal oxide such as titanium oxide (TiO₂), tin oxide (SnO₂), silicon oxide (silica), zinc oxide, calcium oxide, aluminum oxide (alumina), or zirconium oxide, a metal sulfate such as barium sulfate or calcium sulfate, a metal nitride such as silicon nitride or aluminum nitride, fine powder of an inorganic substance such as calcium carbonate, or other additives for provision of electric conductivity. The content of this additive may be varied so long as it allows formation of a stable layer.

A binder resin for the undercoat layer in a case of a positive charging type photoconductor may contain a hole transport substance for the provision of hole transport ability and the reduction of charge trapping. The content of the hole transport substance is favorable in the range from 0.1 to 60 wt %, more preferably from 5 to 40 wt % with respect to the solid component of the undercoat layer. The other known additives may be contained in the undercoat layer as long as they do not materially impair the electrophotographic performance.

The undercoat layer may be a single layer or a lamination of two or more different layers. The thickness of the undercoat layer may vary as long as it exerts no adverse effect, such as an increase of residual potential upon repeated operations, and the composition of the undercoat layer has to be considered. For example, the composition is required to provide a stable layer.

The charge generation layer is formed by vacuum deposition of a charge generation substance of an organic photoconductive substance, or by applying a material with particles of the charge generation substance dispersed in resin binder. The charge generation layer generates charges upon receipt of light. The charge generation layer requires high charge generation efficiency. At the same time, the performance of injecting the generated charges into the charge transport layer is important, and little electric field dependence and sufficient injection even at a low electric field are desired.

The charge generation layer contains a subcomponent of a phthalocyanine compound having central elements of hydrogen in a specified proportion in addition to a principal component of a metallophthalocyanine. Such a composition significantly enhances sensitivity. Although a mechanism for the enhancement has not been fully understood, the following reason can be submitted. The sensitivity enhancement may be brought about by addition of a subcomponent that may improve minute lattice defects undetectable by X-ray diffraction analysis or the like, and may improve stacking characteristics in a microscopic region. The enhancement may also result from an intrinsic function of the subcomponent compound itself.

In embodiments of the present invention, the metallophthalocyanine comprises a compound that contains an atom of a metallic element at the center of a phthalocyanine ring, and the phthalocyanine compound having central elements of hydrogen comprises a compound that contains two hydrogen atoms at a center of a phthalocyanine ring.

The phthalocyanine compounds that can be employed in embodiments of the present invention can be synthesized by the methods disclosed, for example, in “Phthalocyanines, ” by C. C. Lezonff et al., 1989, VCM Publishers Inc., and “The Phthalocyanines,” by F. H. Moser et al., 1983, CRC Press.

The principal component of the metallophthalocyanine preferably has a metallic element of titanium at the center of a phthalocyanine ring; for example, titanylphthalocyanine, in particular, is preferable. Favorable titanylphthalocyanines include α-type titanylphthalocyanine, β-type titanylphthalocyanine, Y-type titanylphthalocyanine, amorphous titanylphthalocyanine, and a titanylphthalocyanine having the largest peak at the Bragg angle 2Θ=9.6° in a CuKα X-ray diffraction spectrum disclosed in Japanese Unexamined Patent Application Publication No. H8-209023. In addition, metallophthalocyanine compounds having a central metallic element of gallium, indium, palladium, or a central metallic element having an oxidation number of three or more is also suitable. Another metallophthalocyanine, a copper phthalocyanine, for example, ε-type copper phthalocyanine, may be used, too.

A subcomponent of a phthalocyanine compound having central elements of hydrogen is preferably a metal-free phthalocyanine. Examples of the metal-free phthalocyanine include X-type metal-free phthalocyanine and τ-type metal-free phthalocyanine. The subcomponent of phthalocyanine compound is in a proportion from 1 μmol to 200 mmol, preferably from 1 μmol to 100 mmol, with respect to 1 mol of the principal component of metallophthalocyanine compound. If the content of the subcomponent is less than 1 μmol, sensitivity enhancement effect cannot be attained; if the content is greater than 200 mmol, the effect saturates and the existence of the subcomponent inhibits the sensitivity enhancement.

Extra phthalocyanine compounds generated in the synthesis process can be removed by sublimation as desired. A phthalocyanine compound having central elements of hydrogen generated as a side product of the synthesis process may also be utilized in embodiments of the present invention.

A charge generation layer for embodiments of the invention essentially contains a principal component of the metallophthalocyanine and a subcomponent of the phthalocyanine compound having central elements of hydrogen. Other charge generation substances may be simultaneously contained in the charge generation layer, for example, pigments or dyes such as azo, anthoanthrone, perylene, perynone, polycyclic quinone, squalirium, thiapyrylium, quinacridone, indigo, cyanine, azulenium compounds. The azo pigments include bis-azo pigments and trisazo pigments; the perylene pigments include N,N′-bis(3,5-dimethylphenyl)-3,4:9,10-perylene bis(carboxyimide).

The resin binder for the charge generation layer can be selected from polymers and copolymers of polycarbonate, polyester, polyamide, polyurethane, epoxy, poly(vinyl butyral), phenoxy, silicone, methacrylate, halides and cyanoethylates of these compounds, and appropriate combinations of these substances. The quantity of the charge generation substance in the charge generation layer is from 10 to 5,000 parts by weight, preferably from 50 to 1,000 parts by weight, with respect to 100 parts by weight of the resin binder.

The film thickness of the charge generation layer is determined by the light absorption coefficient of the charge generation substance, and generally at most 5 μm, preferably not more than 1 μm. The charge generation layer principally contains the charge generation substance, and optionally contains additives of the charge transport substance or other materials.

The charge transport layer is a coating film composed of a single or appropriately combined plurality of charge transport substances with the hole transport property dispersed in a resin binder. The charge transport substances include hydrazone compounds, styryl compounds, amine compounds, and derivatives of these compounds. The charge transport layer acts as an insulator and holds charges in the dark, while it transports charges injected from the charge generation layer upon receipt of light. Binder resins used in the charge transport layer include polymers, mixed polymers, and copolymers of polycarbonate, polyester, polystylene, and polymethacrylate. Compatibility with the charge transport substance is important for the resin binder, as well as mechanical, chemical, and electrical stability, and adhesiveness. The quantity of the charge transport substance in the charge transport layer is in the range from 20 to 500 parts by weight, preferably from 30 to 300 parts by weight, with respect to 100 parts by weight of the resin binder. The thickness of the charge transport layer is preferably in the range from 3 to 50 μm, more preferably from 15 to 40 μm in order to hold an effective surface potential.

A single layer type photosensitive layer is mainly composed of a charge generation substance, a hole transport substance and an electron transport substance (a compound with a nature of an acceptor) as charge transport substances, and a binder resin. This single layer type photosensitive layer, as in the layered type, necessarily includes a principal component of a metallophthalocyanine compound as a charge generation substance and a subcomponent of a phthalocyanine having central elements of hydrogen in a proportion of 1 μmol to 200 mmol with respect to 1 mol of the principal component in embodiments of the present invention. The other charge generation substances described above in the case of the layered type may also be used. Content of the charge generation substance in the single layer type photosensitive layer is in the range from 0.1 to 20 wt %, preferably from 0.5 to 10 wt % of the solid component of the photosensitive layer.

The hole transport substances for the negative charging layered type may also be used in the single layer type photosensitive layer, for example, a hydrazone compound, a pyrazoline compound, a pyrazolone compound, an oxadiazole compound, an oxazole compound, an arylamine compound, a benzidine compound, a stylbene compound, a styryl compound, poly-N-vinylcarbazole, and polysilane. These hole transport substances may be used alone or in a combination of two or more substances. The hole transport substance exhibits high capability of hole transport upon receipt of light, and also exhibits appropriate combination with the charge generation substance. The content of the hole transport substance is in the range from 5 to 80 wt %, preferably from 10 to 60 wt %, of the solid component of the photosensitive layer.

The electron transport substance (a compound with a nature of an acceptor) may be selected from succinic anhydride, maleic anhydride, dibromosuccinic anhydride, phthalic anhydride, 3-nitrophthalic anhydride, 4-nitrophthalic anhydride, pyromellitic anhydride, pyromellitic acid, trimellitic acid, trimellitic anhydride, phthalimide, 4-nitrophthalimide, tetracyanoethylene, tetracyanoquinodimethane, chloranyl, bromanyl, o-nitrobenzoic acid, malononitrile, trinitrofluorenone, trinitrothioxanthone, dinitrobenzene, dinitroanthracene, dinitroacridine, nitroanthraquinone, dinitroanthraquinone, thiopyran compound, quinone compound, benzoquinone compound, diphenoquinone compound, naphthoquinone compound, anthraquinone compound, stilbenequinone compound, and azoquinone compound. These electron transport substances may be used alone or in a combination of two or more substances. The content of the electron transport substance is in the range from 1 to 50 wt %, preferably, from 5 to 40 wt %, of the solid component of the photosensitive layer.

The binder resin of the photosensitive layer of single layer type may be selected from the same binder resins as the binder resins in the charge generation layer or the charge transport layer described above. Examples of the binder resins are polymers and copolymers of polycarbonate resin, polyester resin, poly(vinyl acetal) resin, poly(vinyl butyral) resin, poly(vinyl alcohol) resin, poly(vinyl chloride) resin, poly(vinyl acetate) resin, polyethylene, polypropylene, polystyrene, acrylic resin, polyurethane resin, epoxy resin, melamine resin, silicone resin, polyamide resin, polyacetal resin, polyallylate resin, polysulfone resin, and polymethacrylate. These compounds may be used alone or in an appropriate combination. The same type of resins with different molecular weights may be used in a mixture. Content of the vender resin is in the range from 10 to 90 wt %, preferably from 20 to 80 wt %, of the solid component of the photosensitive layer.

The photosensitive layer can contain an antioxidant and an inhibiter to photo-degradation, for the purpose of improving resistance to severe environmental conditions of harmful light. The compounds used for these purposes include esterified compounds and derivatives of chromanol such as tocopherol, poly(aryl alkane) compound, hydroquinone derivative, esterified compound, and dietherified compound, benzophenone derivative, benzotriazole derivative, thioether compound, phenylenediamine derivative, phosphonate, phosphate, phenol compound, hindered phenol compound, straight chain amine compound, cyclic amine compound, and hindered amine compound.

The photosensitive layer may contain a leveling agent such as silicone oil or fluorine oil for the purpose of improving a leveling quality of the formed film and providing lubrication The photosensitive layer may also contain the fine particles of metal oxides as previously described, particles of fluorine-containing resin such as polytetrafluoroethylene resin, or a fluorine-containing comb type graft copolymer for the purpose of reduction of the friction coefficient and the provision of lubrication. Other known additives may also be used in the photosensitive layer as required, as long as no substantial deterioration occurs in the electrophotographic performance. A favorable thickness of the single layer type photosensitive layer is in the range from 3 to 100 μm, more preferably from 10 to 50 μm, in order to hold an effective surface potential.

A protective layer may be provided as required to enhance durability in repeated printings. The protective layer may be composed, for example mainly of binder resin or an inorganic film of amorphous carbon. The binder resin may contain fine particles of metal oxide, metal sulfate, or metal nitride as described previously to enhance conductivity, decrease a friction coefficient, or give lubricity. The binder resin may also contain a hole transport substance or an electron transport substance as mentioned earlier for charge transport ability, or contain a leveling agent of silicone oil or a fluorine-containing oil for improving leveling performance or giving lubricity to the formed film. Other known additives may be further utilized in the protective layer as required, as long as they do not adversely affect photoconductive performance.

The layers of a photoconductor can be applied and formed by preparing a coating liquid by dissolving and dispersing the above-described constituent materials with an appropriate solvent using a known method of a paint shaker, a ball mill, or ultrasonic dispersion, and then applying the coating liquid to form a layer using a known coating method selected from dip-coating, spray coating, blade coating, roller coating, spiral coating, and slide hopper coating, or the like and finally drying.

The solvent for preparing the coating liquid may be selected from many types of organic solvents. An organic solvent for the coating liquid of the undercoat layer may be selected from an ether solvent such as dimethyl ether, diethyl ether, 1,4-dioxane, tetrahydrofuran, tetrahydropyran, ethylene glycol dimethyl ether, diethylene glycol dimethyl ether, and a ketone solvent such as acetone, methyl ethyl ketone, cyclohexanone, methyl isobutyl ketone, methyl isopropyl ketone. These solvents may be effectively used alone or in a mixture of two or more solvents, or may be mixed with other solvents.

An organic solvent used in a coating liquid to form a photosensitive layer of a layered type or a single layer type preferably exhibits low solubility for the undercoat layer material when the photosensitive layer is formed on the undercoat layer, and preferably dissolves the material used for the photosensitive layer. Useful solvents include hydrocarbon halides such as dichloromethane, dichloroethane, trichloroethane, chloroform, and chlorobenzene. These solvents may be effectively used alone or in an appropriate combination. These solvents may be mixed with other organic solvents as well. An organic solvent used in the coating liquid to form a protective layer may be selected from any solvents that do not dissolve the layer beneath the protective layer, but do dissolve materials for the protective layer.

According to an embodiment of the present invention, a method to manufacture a photoconductor comprises coating and forming a photosensitive layer on a conductive substrate using a coating liquid containing a principal component of a metallophthalocyanine compound and a subcomponent of a phthalocyanine compound having central elements of hydrogen in a proportion of 1 μmol to 200 mmol with respect to 1 mol of the principal component. Other special conditions are not imposed in the manufacturing method. In other words, a method for this embodiment of the invention comprises forming a charge generation layer in a case of a layered type photoconductor or a single photosensitive layer in a case of a single layer type photoconductor, by using the above-specified coating liquid.

### EXAMPLES

The present invention is described below referring to specific examples for the embodiments. The scope of the invention, however, shall not be limited to the examples or embodiments described herein.

### Examples 1 through 6 and Comparative Examples 1 and 2

### Example 1

Forming an Undercoat Layer

A coating liquid for an undercoat layer was prepared by mixing 70 parts by weight of a polyamide resin (AMILAN CM8000 manufactured by Toray Industries Inc.) and 930 parts by weight of methanol. The coating liquid was applied onto an aluminum substrate by a dip-coating method to form an undercoat layer having a dry thickness of 0.5 μm.

Synthesis of titanyloxophthalocyanine

800 g of o-phthalodinitrile (manufactured by Tokyo Kasei Kogyo Co., Ltd.) and 1.8 liters of quinoline (manufactured by Wako Pure Chemicals Ltd.) were put into a reactor vessel and stirred. 297 g of titanium tetrachloride (manufactured by Kishida Chemical Co., Ltd.) was dropped into the vessel and stirred under a dry nitrogen atmosphere. Then, the mixture was heated up to 180° C. in 2 hr, and held at that temperature and stirred for 15 hr.

The reacted liquid was left to cool down to 130° C. and filtered, followed by washing with 3 liters of N-methyl-2-pyrrolidinone. The wet cake was heated in 1.8 liters of N-methyl-2-pyrrolidinone at 160° C. and stirred for 1 hr under a nitrogen atmosphere. This liquid was left to cool and filtered, and then sequentially washed with 3 liters of N-methyl-2-pyrrolidinone, 2 liters of acetone, 2 liters of methanol, and 4 liters of warm water.

The thus obtained wet cake of titanyloxophthalocyanine was heated and stirred in diluted hydrochloric acid composed of 360 ml of 36% hydrochloric acid and 4 liters of water at 80° C. for 1 hr. This liquid was left to cool, filtered, and washed with 4 liters of warm water, followed by drying. This substance was purified three times by means of the vacuum sublimation method, followed by drying. 200 g of the obtained dry substance was put into 4 kg of 96% sulfuric acid at −5° C., and stirred and cooled to retain the temperature at −5° C. or lower for 1 hr. This sulfuric acid solution was added to 35 liters of water and 5 kg of ice while cooling and stirring to keep the temperature within 10° C., and cooled and stirred for 1 hr. This liquid was filtered and then washed with 10 liters of warm water.

This substance was then heated and stirred in diluted hydrochloric acid composed of 770 ml of 36% hydrochloric acid and 10 liters of water, at 80° C. for 1 hr. This liquid was left to cool, filtered, washed with 10 liters of warm water, and dried. This substance was purified by sublimation to obtain pure titanyloxophthalocyanine.

Synthesis of Metal-Free phthalocyanine

Metal-free phthalocyanine was synthesized by the method disclosed in Example 2 in Japanese Unexamined Patent Application Publication No. H7-207183. The resulted substance was purified by sublimation to obtain pure metal-free phthalocyanine.

Forming a Charge Generation Layer

One μmol (=0.51455 mg) of the obtained metal-free phthalocyanine was added to the 1 mol (=576.44 g) of the titanyloxophthalocyanine. This mixed material, 0.5 liter of water, and 1.5 liters of o-dichlorobenzene were put into a ball mill containing 6.6 kg of zirconia balls with 8 mm diameter, and milled for 24 hr. The resulted material was then extracted with 1.5 liters of acetone and 1.5 liters of methanol, then filtered, washed with 1.5 liters of water, and dried.

Ten parts by weight of the obtained metal-free phthalocyanine-containing titanyloxophthalocyanine was mixed with 10 parts by weight of vinyl chloride resin (MR-110 manufactured by ZEON Corporation), 686 parts by weight of dichloromethane, and 294 parts by weight of 1,2-dichloroethane, and ultrasonically dispersed, to obtain coating liquid for a charge generation layer. This coating liquid was applied onto the undercoat layer as described previously, by means of dip-coating method. Thus, a charge generation layer having the dried thickness of 0.2 μm was formed.

Forming a Charge Transport Layer

Coating liquid for a charge transport layer was prepared by mixing 100 parts by weight of 4-(diphenylamino) benzaldehyde phenyl (2-thienylmethyl) hydrazone (manufactured by Fuji Electric Co. Ltd.), 100 parts by weight of a polycarbonate resin (PANLITE K-1300 manufactured by Teijin Chemicals Ltd.), 800 parts by weight of dichloromethane, 1 part by weight of silane coupling agent, and 4 parts by weight of bis(2,4-di-tert-butyl phenyl) phenylphosphonite (manufactured by Fuji Electric Co. Ltd.). This coating liquid was applied onto the charge generation layer as described above, by dip-coating to form a charge transport layer having the dried thickness of 20 μm. Thus, an electrophotographic photoconductor was manufactured.

### Example 2

An electrophotographic photoconductor was manufactured in the same manner as in Example 1, except that the content of the metal-free phthalocyanine was changed to 50 μmol with respect to 1 mol of the titanyloxophthalocyanine.

### Example 3

An electrophotographic photoconductor was manufactured in the same manner as in Example 1, except that the content of the metal-free phthalocyanine was changed to 1 mmol with respect to 1 mol of the titanyloxophthalocyanine.

### Example 4

An electrophotographic photoconductor was manufactured in the same manner as in Example 1, except that the content of the metal-free phthalocyanine was changed to 10 mmol with respect to 1 mol of the titanyloxophthalocyanine.

### Example 5

An electrophotographic photoconductor was manufactured in the same manner as in Example 1, except that the content of the metal-free phthalocyanine was changed to 100 mmol with respect to 1 mol of the titanyloxophthalocyanine.

### Example 6

An electrophotographic photoconductor was manufactured in the same manner as in Example 1, except that the content of the metal-free phthalocyanine was changed to 200 mmol with respect to 1 mol of the titanyloxophthalocyanine.

### Comparative Example 1

An electrophotographic photoconductor was manufactured in the same manner as in Example 1, except that the content of the metal-free phthalocyanine was changed to 100 nmol with respect to 1 mol of the titanyloxophthalocyanine.

### Comparative Example 2

An electrophotographic photoconductor was manufactured in the same manner as in Example 1, except that the content of the metal-free phthalocyanine was changed to 300 mmol with respect to 1 mol of the titanyloxophthalocyanine.

Electrical performances of the thus obtained photoconductors were measured using an electrostatic recording paper testing apparatus (EPA-8200 manufactured by Kawaguchi Electric Works Co., Ltd.). Table 1 shows the measurement results on the sensitivity E1/2 (μJ/cm²) during half decay period from −600 V to −300 V and E100 (μJ/cm²) during decay period from −600 V to −100 V.

TABLE 1

| | sensitivity E1/2 (μJ/cm²) | sensitivity E100 (μJ/cm²) |
|---|---|---|
| Example 1 | 0.14 | 0.31 |
| Example 2 | 0.13 | 0.30 |
| Example 3 | 0.14 | 0.31 |
| Example 4 | 0.14 | 0.32 |
| Example 5 | 0.15 | 0.34 |
| Example 6 | 0.16 | 0.38 |
| Comp Example 1 | 0.29 | 0.80 |
| Comp Example 2 | 0.31 | 0.85 |

As is apparent from Table 1, every Example exhibited a satisfactorily high sensitivity, while every Comparative Example exhibited a lower sensitivity than the Examples.

### Examples 7 through 12 and Comparative Examples 3 and 4

### Example 7

An electrophotographic photoconductor was manufactured in the same manner as in Example 1, except that the titanyloxophthalocyanine in the Example 1 was replaced by quasi amorphous titanyloxophthalocyanine synthesized according to the method disclosed in the example 1 of Japanese Unexamined Patent Application Publication No. H1-123868.

### Example 8

An electrophotographic photoconductor was manufactured in the same manner as in Example 7, except that the content of the metal-free phthalocyanine was changed to 50 μmol with respect to 1 mol of the quasi amorphous titanyloxophthalocyanine.

### Example 9

An electrophotographic photoconductor was manufactured in the same manner as in Example 7, except that the content of the metal-free phthalocyanine was changed to 1 mmol with respect to 1 mol of the quasi amorphous titanyloxophthalocyanine.

### Example 10

An electrophotographic photoconductor was manufactured in the same manner as in Example 7, except that the content of the metal-free phthalocyanine was changed to 10 mmol with respect to 1 mol of the quasi amorphous titanyloxophthalocyanine.

### Example 11

An electrophotographic photoconductor was manufactured in the same manner as in Example 7, except that the content of the metal-free phthalocyanine was changed to 100 mmol with respect to 1 mol of the quasi amorphous titanyloxophthalocyanine.

### Example 12

An electrophotographic photoconductor was manufactured in the same manner as in Example 7, except that the content of the metal-free phthalocyanine was changed to 200 mmol with respect to 1 mol of the quasi amorphous titanyloxophthalocyanine.

### Comparative Example 3

An electrophotographic photoconductor was manufactured in the same manner as in Example 7, except that the content of the metal-free phthalocyanine was changed to 100 nmol with respect to 1 mol of the quasi amorphous titanyloxophthalocyanine.

### Comparative Example 4

An electrophotographic photoconductor was manufactured in the same manner as in Example 7, except that the content of the metal-free phthalocyanine was changed to 300 mmol with respect to 1 mol of the quasi amorphous titanyloxophthalocyanine.

Electrical performances of the thus obtained photoconductors were measured using the electrostatic recording paper testing apparatus (EPA-8200 manufactured by Kawaguchi Electric Works Co., Ltd.) as in Example 1. Table 2 shows the measurement results on the sensitivity E1/2 (μJ/cm²) and E100 (μJ/cm²).

TABLE 2

| | sensitivity E1/2 | sensitivity E100 |
|---|---|---|
| | (μJ/cm²) | (μJ/cm²) |
| Example 7 | 0.18 | 0.58 |
| Example 8 | 0.17 | 0.55 |
| Example 9 | 0.17 | 0.56 |
| Example 10 | 0.18 | 0.57 |
| Example 11 | 0.19 | 0.59 |
| Example 12 | 0.21 | 0.67 |
| Comp Example 3 | 0.39 | 1.11 |
| Comp Example 4 | 0.42 | 1.20 |

As is apparent from Table 2, every Example exhibited a satisfactorily high sensitivity, while every Comparative Example exhibited a lower sensitivity than the Examples.

### Examples 13 through 18 and Comparative Examples 5 and 6

### Example 13

An electrophotographic photoconductor was manufactured in the same manner as in Example 1, except that the titanyloxophthalocyanine in the Example 1 was replaced by α type titanyloxophthalocyanine synthesized according to a common method.

### Example 14

An electrophotographic photoconductor was manufactured in the same manner as in Example 13, except that the content of the metal-free phthalocyanine was changed to 50 μmol with respect to 1 mol of the α type titanyloxophthalocyanine.

### Example 15

An electrophotographic photoconductor was manufactured in the same manner as in Example 13, except that the content of the metal-free phthalocyanine was changed to 1 mmol with respect to 1 mol of the α type titanyloxophthalocyanine.

### Example 16

An electrophotographic photoconductor was manufactured in the same manner as in Example 13, except that the content of the metal-free phthalocyanine was changed to 10 mmol with respect to 1 mol of the α type titanyloxophthalocyanine.

### Example 17

An electrophotographic photoconductor was manufactured in the same manner as in Example 13, except that the content of the metal-free phthalocyanine was changed to 100 mmol with respect to 1 mol of the α type titanyloxophthalocyanine.

### Example 18

An electrophotographic photoconductor was manufactured in the same manner as in Example 13, except that the content of the metal-free phthalocyanine was changed to 200 mmol with respect to 1 mol of the α type titanyloxophthalocyanine.

### Comparative Example 5

An electrophotographic photoconductor was manufactured in the same manner as in Example 13, except that the content of the metal-free phthalocyanine was changed to 100 nmol with respect to 1 mol of the α type titanyloxophthalocyanine.

### Comparative Example 6

An electrophotographic photoconductor was manufactured in the same manner as in Example 13, except that the content of the metal-free phthalocyanine was changed to 300 mmol with respect to 1 mol of the α type titanyloxophthalocyanine.

Electrical performances of the thus obtained photoconductors were measured using the electrostatic recording paper testing apparatus (EPA-8200 manufactured by Kawaguchi Electric Works Co., Ltd.) as in Example 1. Table 3 shows the measurement results on the sensitivity E1/2 (μJ/cm²) and E100 (μJ/cm²).

TABLE 3

| | sensitivity E1/2 (μJ/cm²) | sensitivity E100 (μJ/cm²) |
|---|---|---|
| Example 13 | 0.17 | 0.55 |
| Example 14 | 0.16 | 0.53 |
| Example 15 | 0.16 | 0.53 |
| Example 16 | 0.17 | 0.55 |
| Example 17 | 0.18 | 0.58 |
| Example 18 | 0.22 | 0.67 |
| Comp Example 5 | 0.36 | 1.05 |
| Comp Example 6 | 0.38 | 1.13 |

As is apparent from Table 3, every Example exhibited a satisfactorily high sensitivity, while every Comparative Example exhibited a lower sensitivity than the Examples.

### Examples 19 through 24 and Comparative Examples 7 and 8

### Example 19

Forming an Undercoat Layer

An undercoat layer 0.2 μm thick was formed by applying coating liquid onto an aluminum substrate by dip-coating method and drying at 100° C. for 30 min. The coating liquid for the undercoat layer was prepared by stirring and dissolving the materials shown below.

“Parts” in the following means “parts by weight.”

Vinyl chloride-vinyl acetate- vinyl alcohol copolymer: 50 parts

(SOLBIN A manufactured by Nissin Chemical Industry Co., Ltd.)

(Vinyl chloride 92%, vinyl acetate 3%, vinyl alcohol 5%).

Methyl ethyl ketone: 950 parts.

Forming a Single Layer Type Photosensitive Layer

Metal-free phthalocyanine was synthesized by the method disclosed in Example 2 in Japanese Unexamined Patent Application Publication No. H7-207183. The resulted substance was purified by sublimation to obtain pure metal-free phthalocyanine. This metal-free phthalocyanine was added to quasi amorphous titanyloxophthalocyanine synthesized according to the method disclosed in the example 1 of Japanese Unexamined Patent Application Publication No. H1-123868 in the proportion of 1 μmol with respect to 1 mol of the quasi amorphous titanyloxophthalocyanine.

For preparing a coating liquid for a single layer type photosensitive layer, a mixture of 2 parts by weight of the quasi amorphous titanyloxophthalocyanine that contains metal-free phthalocyanine, 65 parts by weight of the hole transport substance represented by the formula HTM-1 below:

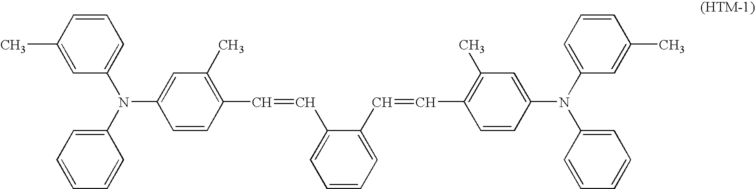

28 parts by weight of the electron transport substance represented by the formula ETM-1 below:

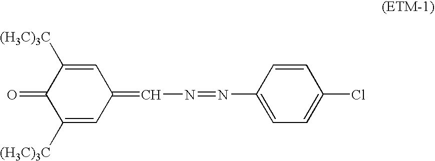

0.1 part by weight of silicone oil (KF-40 manufactured by Shin-Etsu Chemical Co., Ltd.), and 1,000 parts by weight of dichloromethane were dispersed by a paint shaker for 1 hr. To this mixture, 105 parts by weight of the polycarbonate resin was added having the repeating unit represented by the formula BD-1 below:

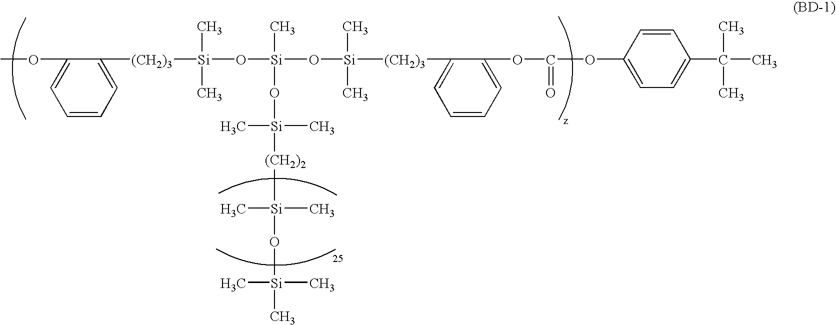

This mixed material was stirred and dissolved, and dispersed by the paint shaker for 1 hr. to obtain a coating liquid for a single layer type photosensitive layer. This coating liquid was applied onto the above-described undercoat layer by dip-coating to form a single layer type photosensitive layer having dried thickness of 25 μm. Thus, an electrophotographic photoconductor of Example 19 was manufactured.

### Example 20

An electrophotographic photoconductor was manufactured in the same manner as in Example 19, except that the content of the metal-free phthalocyanine was changed to 50 μmol with respect to 1 mol of the quasi amorphous titanyloxophthalocyanine.

### Example 21

An electrophotographic photoconductor was manufactured in the same manner as in Example 19, except that the content of the metal-free phthalocyanine was changed to 1 mmol with respect to 1 mol of the quasi amorphous titanyloxophthalocyanine.

### Example 22

An electrophotographic photoconductor was manufactured in the same manner as in Example 19, except that the content of the metal-free phthalocyanine was changed to 10 mmol with respect to 1 mol of the quasi amorphous titanyloxophthalocyanine.

### Example 23

An electrophotographic photoconductor was manufactured in the same manner as in Example 19, except that the content of the metal-free phthalocyanine was changed to 100 nmol with respect to 1 mol of the quasi amorphous titanyloxophthalocyanine.

### Example 24

An electrophotographic photoconductor was manufactured in the same manner as in Example 19, except that the content of the metal-free phthalocyanine was changed to 200 mmol with respect to 1 mol of the quasi amorphous titanyloxophthalocyanine.

### Comparative Example 7

An electrophotographic photoconductor was manufactured in the same manner as in Example 19, except that the content of the metal-free phthalocyanine was changed to 100 nmol with respect to 1 mol of the quasi amorphous titanyloxophthalocyanine.

### Comparative Example 8

An electrophotographic photoconductor was manufactured in the same manner as in Example 19, except that the content of the metal-free phthalocyanine was changed to 300 mmol with respect to 1 mol of the quasi amorphous titanyloxophthalocyanine.

Electrical performances of the thus obtained photoconductors were measured using the electrostatic recording paper testing apparatus (EPA-8200 manufactured by Kawaguchi Electric Works Co., Ltd.). Table 4 shows the measurement results on the sensitivity E1/2 (μJ/cm²) during half decay period from +600 V to +300 V and E100 (μJ/cm²) during decay period from +600 V to +100 V.

TABLE 4

| | sensitivity E1/2 (μJ/cm²) | sensitivity E100 (μJ/cm²) |
|---|---|---|
| Example 19 | 0.20 | 0.61 |
| Example 20 | 0.19 | 0.58 |
| Example 21 | 0.19 | 0.58 |
| Example 22 | 0.19 | 0.59 |
| Example 23 | 0.20 | 0.61 |
| Example 24 | 0.21 | 0.68 |
| Comp Example 7 | 0.37 | 1.10 |
| Comp Example 8 | 0.35 | 1.02 |

As is apparent from Table 4, every Example exhibited a satisfactorily high sensitivity, while every Comparative Example exhibited a lower sensitivity than the Examples.

### Examples 25 through 30 and Comparative Examples 9 and 10

### Example 25

An electrophotographic photoconductor was manufactured in the same manner as in Example 1, except that the titanyloxophthalocyanine in the Example 1 was replaced by chlorogallium phthalocyanine synthesized as is known in the art.

### Example 26

An electrophotographic photoconductor was manufactured in the same manner as in Example 25, except that the content of the metal-free phthalocyanine was changed to 50 μmol with respect to 1 mol of the chlorogallium phthalocyanine.

### Example 27

An electrophotographic photoconductor was manufactured in the same manner as in Example 25, except that the content of the metal-free phthalocyanine was changed to 1 mmol with respect to 1 mol of the chlorogallium phthalocyanine.

### Example 28

An electrophotographic photoconductor was manufactured in the same manner as in Example 25, except that the content of the metal-free phthalocyanine was changed to 10 mmol with respect to 1 mol of the chlorogallium phthalocyanine.

### Example 29

An electrophotographic photoconductor was manufactured in the same manner as in Example 25, except that the content of the metal-free phthalocyanine was changed to 100 mmol with respect to 1 mol of the chlorogallium phthalocyanine.

### Example 30

An electrophotographic photoconductor was manufactured in the same manner as in Example 25, except that the content of the metal-free phthalocyanine was changed to 200 mmol with respect to 1 mol of the chlorogallium phthalocyanine.

### Comparative Example 9

An electrophotographic photoconductor was manufactured in the same manner as in Example 25, except that the content of the metal-free phthalocyanine was changed to 100 nmol with respect to 1 mol of the chlorogallium phthalocyanine.

### Comparative Example 10

An electrophotographic photoconductor was manufactured in the same manner as in Example 25, except that the content of the metal-free phthalocyanine was changed to 300 mmol with respect to 1 mol of the chlorogallium phthalocyanine.

Electrical performances of the thus obtained photoconductors were measured using an electrostatic recording paper testing apparatus (EPA-8200 manufactured by Kawaguchi Electric Works Co., Ltd.). Table 5 shows the measurement results on the sensitivity E1/2 (μJ/cm²) and E100 (μJ/cm²).

TABLE 5

| | sensitivity E1/2 (μJ/cm²) | sensitivity E100 (μJ/cm²) |
|---|---|---|
| Example 25 | 0.21 | 0.59 |
| Example 26 | 0.20 | 0.58 |
| Example 27 | 0.20 | 0.58 |
| Example 28 | 0.20 | 0.57 |
| Example 29 | 0.21 | 0.60 |
| Example 30 | 0.22 | 0.62 |
| Comp Example 9 | 0.36 | 1.11 |
| Comp Example 10 | 0.40 | 1.26 |

As is apparent from Table 5, every Example exhibited a satisfactorily high sensitivity, while every Comparative Example exhibited a lower sensitivity than the Examples.

### Examples 31 through 36 and Comparative Examples 11 and 12

### Example 31

An electrophotographic photoconductor was manufactured in the same manner as in Example 1, except that the titanyloxophthalocyanine in the Example 1 was replaced by chloroindium phthalocyanine synthesized as is known in the art.

### Example 32

An electrophotographic photoconductor was manufactured in the same manner as in Example 31, except that the content of the metal-free phthalocyanine was changed to 50 μmol with respect to 1 mol of the chloroindium phthalocyanine.

### Example 33

An electrophotographic photoconductor was manufactured in the same manner as in Example 31, except that the content of the metal-free phthalocyanine was changed to 1 mmol with respect to 1 mol of the chloroindium phthalocyanine.

### Example 34

An electrophotographic photoconductor was manufactured in the same manner as in Example 31, except that the content of the metal-free phthalocyanine was changed to 10 mmol with respect to 1 mol of the chloroindium phthalocyanine.

### Example 35

An electrophotographic photoconductor was manufactured in the same manner as in Example 31, except that the content of the metal-free phthalocyanine was changed to 100 mmol with respect to 1 mol of the chloroindium phthalocyanine.

### Example 36

An electrophotographic photoconductor was manufactured in the same manner as in Example 31, except that the content of the metal-free phthalocyanine was changed to 200 mmol with respect to 1 mol of the chloroindium phthalocyanine.

### Comparative Example 11

An electrophotographic photoconductor was manufactured in the same manner as in Example 31, except that the content of the metal-free phthalocyanine was changed to 100 nmol with respect to 1 mol of the chloroindium phthalocyanine.

### Comparative Example 12

An electrophotographic photoconductor was manufactured in the same manner as in Example 31, except that the content of the metal-free phthalocyanine was changed to 300 mmol with respect to 1 mol of the chloroindium phthalocyanine.

Electrical performances of the thus obtained photoconductors were measured using an electrostatic recording paper testing apparatus (EPA-8200 manufactured by Kawaguchi Electric Works Co., Ltd.). Table 6 shows the measurement results on the sensitivity E1/2 (μJ/cm²) and E100 (μJ/cm²).\

TABLE 6

| | sensitivity E1/2 (μJ/cm²) | sensitivity E100 (μJ/cm²) |
|---|---|---|
| Example 31 | 0.26 | 0.65 |
| Example 32 | 0.24 | 0.63 |
| Example 33 | 0.24 | 0.63 |
| Example 34 | 0.25 | 0.64 |
| Example 35 | 0.26 | 0.66 |
| Example 36 | 0.28 | 0.70 |
| Comp Example 11 | 0.40 | 1.21 |
| Comp Example 12 | 0.41 | 1.32 |

As is apparent from Table 6, every Example exhibited a satisfactorily high sensitivity, while every Comparative Example exhibited a lower sensitivity than the Examples.

### Examples 37 through 42 and Comparative Examples 13 and 14

### Example 37

An electrophotographic photoconductor was manufactured in the same manner as in Example 1, except that the titanyloxophthalocyanine in the Example 1 was replaced by vanadyloxophthalocyanine synthesized as is known in the art.

### Example 38

An electrophotographic photoconductor was manufactured in the same manner as in Example 37, except that the content of the metal-free phthalocyanine was changed to 50 μmol with respect to 1 mol of the vanadyloxophthalocyanine.

### Example 39

An electrophotographic photoconductor was manufactured in the same manner as in Example 37, except that the content of the metal-free phthalocyanine was changed to 1 mmol with respect to 1 mol of the vanadyloxophthalocyanine.

### Example 40

An electrophotographic photoconductor was manufactured in the same manner as in Example 37, except that the content of the metal-free phthalocyanine was changed to 10 mmol with respect to 1 mol of the vanadyloxophthalocyanine.

### Example 41

An electrophotographic photoconductor was manufactured in the same manner as in Example 37, except that the content of the metal-free phthalocyanine was changed to 100 mmol with respect to 1 mol of the vanadyloxophthalocyanine.

### Example 42

An electrophotographic photoconductor was manufactured in the same manner as in Example 37, except that the content of the metal-free phthalocyanine was changed to 200 mmol with respect to 1 mol of the vanadyloxophthalocyanine.

### Comparative Example 13

An electrophotographic photoconductor was manufactured in the same manner as in Example 37, except that the content of the metal-free phthalocyanine was changed to 100 nmol with respect to 1 mol of the vanadyloxophthalocyanine.

### Comparative Example 14

An electrophotographic photoconductor was manufactured in the same manner as in Example 37, except that the content of the metal-free phthalocyanine was changed to 300 mmol with respect to 1 mol of the vanadyloxophthalocyanine.

Electrical performances of the thus obtained photoconductors were measured using an electrostatic recording paper testing apparatus (EPA-8200 manufactured by Kawaguchi Electric Works Co., Ltd.). Table 7 shows the measurement results on the sensitivity E1/2 (μJ/cm²) and E100 (μJ/cm²).

TABLE 7

| | sensitivity E1/2 (μJ/cm²) | sensitivity E100 (μJ/cm²) |
|---|---|---|
| Example 37 | 0.22 | 0.63 |
| Example 38 | 0.21 | 0.61 |
| Example 39 | 0.21 | 0.62 |
| Example 40 | 0.22 | 0.64 |
| Example 41 | 0.23 | 0.65 |
| Example 42 | 0.25 | 0.74 |
| Comp Example 13 | 0.43 | 1.22 |
| Comp Example 14 | 0.48 | 1.30 |

As is apparent from Table 7, every Example exhibited a satisfactorily high sensitivity, while every Comparative Example exhibited a lower sensitivity than the Examples.

### Examples 43 through 48 and Comparative Examples 15 and 16

### Example 43

An electrophotographic photoconductor was manufactured in the same manner as in Example 1, except that the titanyloxophthalocyanine in the Example 1 was replaced by palladium phthalocyanine synthesized as is known in the art.

### Example 44

An electrophotographic photoconductor was manufactured in the same manner as in Example 43, except that the content of the metal-free phthalocyanine was changed to 50 μmol with respect to 1 mol of the palladium phthalocyanine.

### Example 45

An electrophotographic photoconductor was manufactured in the same manner as in Example 43, except that the content of the metal-free phthalocyanine was changed to 1 mmol with respect to 1 mol of the palladium phthalocyanine.

### Example 46

An electrophotographic photoconductor was manufactured in the same manner as in Example 43, except that the content of the metal-free phthalocyanine was changed to 10 mmol with respect to 1 mol of the palladium phthalocyanine.

### Example 47

An electrophotographic photoconductor was manufactured in the same manner as in Example 43, except that the content of the metal-free phthalocyanine was changed to 100 mmol with respect to 1 mol of the palladium phthalocyanine.

### Example 48

An electrophotographic photoconductor was manufactured in the same manner as in Example 43, except that the content of the metal-free phthalocyanine was changed to 200 mmol with respect to 1 mol of the palladium phthalocyanine.

### Comparative Example 15

An electrophotographic photoconductor was manufactured in the same manner as in Example 43, except that the content of the metal-free phthalocyanine was changed to 100 nmol with respect to 1 mol of the palladium phthalocyanine.

### Comparative Example 16

An electrophotographic photoconductor was manufactured in the same manner as in Example 43, except that the content of the metal-free phthalocyanine was changed to 300 mmol with respect to 1 mol of the palladium phthalocyanine.

Electrical performances of the thus obtained photoconductors were measured using an electrostatic recording paper testing apparatus (EPA-8200 manufactured by Kawaguchi Electric Works Co., Ltd.). Table 8 shows the measurement results on the sensitivity E1/2 (μJ/cm²) and E100 (μJ/cm²).

TABLE 8

| | sensitivity E1/2 (μJ/cm²) | sensitivity E100 (μJ/cm²) |
|---|---|---|
| Example 43 | 0.33 | 0.90 |
| Example 44 | 0.31 | 0.86 |
| Example 45 | 0.31 | 0.87 |
| Example 46 | 0.32 | 0.89 |
| Example 47 | 0.34 | 0.91 |
| Example 48 | 0.35 | 0.94 |
| Comp Example 15 | 0.47 | 1.42 |
| Comp Example 16 | 0.45 | 1.37 |

As is apparent from Table 8, every Example exhibited a relatively high sensitivity, while every Comparative Example exhibited a lower sensitivity than the Examples.

### Examples 49 through 54 and Comparative Examples 17 and 18

### Example 49

An electrophotographic photoconductor was manufactured in the same manner as in Example 1, except that the titanyloxophthalocyanine in the Example 1 was replaced by titanylphthalocyanine 2,3-butandiol complex synthesized according to the method disclosed in Synthesis Example 1 in Japanese Unexamined Patent application Publication No. H5-273775.

### Example 50

An electrophotographic photoconductor was manufactured in the same manner as in Example 49, except that the content of the metal-free phthalocyanine was changed to 50 μmol with respect to 1 mol of the titanylphthalocyanine complex.

### Example 51

An electrophotographic photoconductor was manufactured in the same manner as in Example 49, except that the content of the metal-free phthalocyanine was changed to 1 mmol with respect to 1 mol of the titanylphthalocyanine complex.

### Example 52

An electrophotographic photoconductor was manufactured in the same manner as in Example 49, except that the content of the metal-free phthalocyanine was changed to 10 mmol with respect to 1 mol of the titanylphthalocyanine complex.

### Example 53

An electrophotographic photoconductor was manufactured in the same manner as in Example 49, except that the content of the metal-free phthalocyanine was changed to 100 mmol with respect to 1 mol of the titanylphthalocyanine complex.

### Example 54

An electrophotographic photoconductor was manufactured in the same manner as in Example 49, except that the content of the metal-free phthalocyanine was changed to 200 mmol with respect to 1 mol of the titanylphthalocyanine complex.

### Comparative Example 17

An electrophotographic photoconductor was manufactured in the same manner as in Example 49, except that the content of the metal-free phthalocyanine was changed to 100 nmol with respect to 1 mol of the titanylphthalocyanine complex.

### Comparative Example 18

An electrophotographic photoconductor was manufactured in the same manner as in Example 49, except that the content of the metal-free phthalocyanine was changed to 300 mmol with respect to 1 mol of the titanylphthalocyanine complex.

Electrical performances of the thus obtained photoconductors were measured using an electrostatic recording paper testing apparatus (EPA-8200 manufactured by Kawaguchi Electric Works Co., Ltd.). Table 9 shows the measurement results on the sensitivity E1/2 (μJ/cm²) and E100 (μJ/cm²).

TABLE 9

| | sensitivity E1/2 (μJ/cm²) | sensitivity E100 (μJ/cm²) |
|---|---|---|
| Example 49 | 0.37 | 1.03 |
| Example 50 | 0.36 | 1.00 |
| Example 51 | 0.36 | 1.01 |
| Example 52 | 0.38 | 1.04 |
| Example 53 | 0.40 | 1.09 |
| Example 54 | 0.44 | 1.17 |
| Comp Example 17 | 0.59 | 1.74 |
| Comp Example 18 | 0.62 | 1.95 |

As is apparent from Table 9, every Example exhibited a relatively high sensitivity, while every Comparative Example exhibited a lower sensitivity than the Examples.

As described, according to embodiments of the present invention there is provided an electrophotographic photoconductor exhibiting excellent electrophotographic performance, particularly sensitivity, by the feature of the invention, in which the photosensitive layer contains two specific types of phthalocyanine compounds in a specified mixing proportion. According to further embodiments of the present invention, there is also provided a method of manufacturing such an electrophotographic photoconductor.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrophotographic photoconductor comprising:
a conductive substrate; and
a photosensitive layer containing photoconductive substances, including a principal component of a metallophthalocyanine compound and a subcomponent of a phthalocyanine compound having central elements of hydrogen, the subcomponent being contained in a proportion of 1 μmol to 200 mmol with respect to 1 mol of the principal component.

2. An electrophotographic photoconductor according to claim 1, wherein the metallophthalocyanine compound has an atom of a metallic element at a center of a phthalocyanine ring, and the phthalocyanine compound having central elements of hydrogen has two hydrogen atoms at a center of a phthalocyanine ring.

3. An electrophotographic photoconductor according to claim 2, wherein the metallic element is titanium.

4. An electrophotographic photoconductor according to claim 1, wherein the metallophthalocyanine compound is titanyloxophthalocyanine.

5. An electrophotographic photoconductor according to claim 2, wherein the metallic element is gallium.

6. An electrophotographic photoconductor according to claim 2, wherein the metallic element is indium.

7. An electrophotographic photoconductor according to claim 2, wherein the metallic element is palladium.

8. An electrophotographic photoconductor according to claim 2, wherein the metallic element is an element that has an oxidation number of at least 3.

9. An electrophotographic photoconductor according to claim 1, wherein the phthalocyanine compound is a metal-free phthalocyanine.

10. An electrophotographic photoconductor according to claim 1, wherein the subcomponent is in a proportion of 1 μmol to 100 mmol with respect to 1 mol of the principal component.

11. A method of manufacturing an electrophotographic photoconductor comprising: coating a conductive substrate with a coating liquid containing a photoconductive substance including a principal component of a metallophthalocyanine compound and a subcomponent of a phthalocyanine compound having central elements of hydrogen, the subcomponent being contained in a proportion of 1 μmol to 200 mmol with respect to 1 mol of the principal component.

12. A method of manufacturing an electrophotographic photoconductor according to claim 11, wherein the metallophthalocyanine compound has an atom of a metallic element at a center of a phthalocyanine ring, and the phthalocyanine compound having central elements of hydrogen has two hydrogen atoms at a center of a phthalocyanine ring.
